(19) United States
(12) Patent Application Publication
(10) Pub. No.: US 2026/0293989 A1
(43) Pub. Date: Oct. 1, 2026

(54) AN AEROSOL-GENERATING DEVICE COMPRISING AN INDUCTOR COIL

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH); Julien VIDAL, Peseux (CH)

(73) Assignee: Philip Morris Products S.A., Neuchatel (CH)

(21) Appl. No.: 19/477,800

(22) PCT Filed: May 2, 2024
(86) PCT No.: PCT/EP2024/062144

§ 371 Date: Oct. 23, 2025

(30) Foreign Application Priority Data
May 2, 2023 (EP) 23171142

(51) Int. Cl. A24F 40/465; A24F 40/42; A24F 40/50; A24F 40/70; H05B 6/10; H05B 6/36

(52) U.S. Cl. CPC A24F 40/465; A24F 40/42; A24F 40/50; A24F 40/70; H05B 6/108; H05B 6/36

(57) ABSTRACT

An aerosol-generating device is provided, including: an inductor coil including a first tubular portion of electrically conductive material, a second tubular portion of electrically conductive material, and a helical coil of electrically conductive material extending between the first tubular portion of electrically conductive material and the second tubular portion of electrically conductive material; a chamber to receive at least a portion of an aerosol-generating article, the inductor coil being arranged such that, when an aerosol-generating article is inserted into the chamber, at least part of the aerosol-generating article is received within the inductor coil and the inductor coil directly contacts the aerosol-generating article; and a power supply and control circuitry connected to the inductor coil and configured to provide an alternating electric current to the inductor coil such that the inductor coil is configured to generate an alternating magnetic field.

The present disclosure relates to an aerosol-generating device comprising an inductor coil. The present invention also relates to a method for forming an inductor coil for an aerosol-generating device.

It is known to evolve an aerosol from an aerosol-forming substrate of an aerosol-generating article by the application of heat to the substrate, without burning or combustion of the substrate. The aerosol-generating article may be cylindrical, like a cigarette, and the aerosol-forming substrate may comprise tobacco material. It is known to apply heat to such an aerosol-generating article to heat the aerosol-forming substrate of the article using a heat source that is external to the aerosol-generating article.

However, an external heat source will tend to heat the aerosol-forming substrate unevenly. The aerosol-forming substrate closest to the heat source will be heated more than the aerosol-forming substrate in the centre of the aerosol-generating article, further from the heat source.

It is also known to heat the aerosol-forming substrate of such an article using a heat source located within the interior of the aerosol-forming substrate. In some aerosol-generating systems the internal heat source is heated inductively using an induction coil positioned externally of the aerosol-generating article and a susceptor material located within a central region of the aerosol-generating article. Internally heating the aerosol-forming substrate avoids heat having to traverse through a wrapper to reach the aerosol-forming substrate. However, internally heating the aerosol-forming substrate also results in the aerosol-forming substrate being heated in a non-uniform manner, with heating of the substrate being greatest at or closest to the internal heat source and reducing with increasing distance away from the internal heat source into the substrate.

Non-uniform heating of the aerosol-forming substrate can mean that not all of the available volatile material is released from the aerosol-forming substrate. This is because increasing the level of heat applied to the substrate in order to fully extract the volatile material from the aerosol-forming substrate when using either external heating or internal heating of the substrate may result in unintended and undesired burning of the substrate close to the heat source, which can give rise to the generation of undesirable compounds and flavours.

It is therefore desired to provide an aerosol-generating device that facilitates efficient and uniform heating of an aerosol-forming substrate without requiring a complex heating arrangement.

According to a first aspect of the disclosure there is provided a method of forming an inductor coil for an aerosol-generating device, the method comprising providing a tube of electrically conductive material and cutting a helical aperture in at least a portion of the tube of electrically conductive material. The helical aperture defines a helical coil of the electrically conductive material, the helical coil of the electrically conductive material forming an inductor coil for an aerosol-generating device. In other words, the helical coil of the electrically conductive material may form a plurality of windings of an inductor coil.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

The term “electrically conductive” is used herein to refer to materials having an electrical conductivity of at least 0.8×10⁶ Siemens per metre. The term “electrically insulating” is used herein to refer to materials having an electrical conductivity of less than 0.8×10⁴ Siemens per metre.

Advantageously, forming an inductor coil from a tube of electrically conductive material may provide an inductor coil having a relatively smooth internal surface when compared to traditional inductor coils formed by twisting a round wire into a helical coil shape. Advantageously, an inductor coil having a relatively smooth internal surface may facilitate insertion of an aerosol-generating article directly into the inductor coil.

The present inventors have recognised that an inductor coil may exhibit heat losses in the form of resistive heating of the inductor coil when an alternating electric current flows through the inductor coil during use. Advantageously, a relatively smooth internal surface of an inductor coil may increase or maximise the surface area of the inductor coil in direct contact with an aerosol-generating article when compared to traditional wound-wire inductor coils. Advantageously, increasing or maximising the surface area of the inductor coil in direct contact with an aerosol-generating article may increase or maximise the transfer of resistively generated heat from the inductor coil to an aerosol-forming substrate of the aerosol-generating article.

The step of cutting a helical aperture may comprise any suitable cutting process. The cutting step may comprise cutting the helical aperture using at least one of a mechanical cutting process, electron discharge machining, and a laser cutter. The cutting step may comprise cutting the helical aperture using a milling process. Preferably, the cutting step comprises cutting the helical aperture using a laser cutter.

The step of cutting a helical aperture may comprise rotating and advancing the tube of electrically conductive material relative to a fixed cutting device. Advantageously, moving the tube of electrically conductive material relative to a fixed cutting device may simplify the cutting process compared to embodiments in which a cutting device is moved relative to the tube of electrically conductive material.

The step of providing a tube of electrically conductive material may comprise positioning the tube of electrically conductive material on a mandrel. In embodiments in which the step of cutting a helical aperture comprises rotating and advancing the tube of electrically conductive material relative to a fixed cutting device, the rotating and advancing the tube of electrically conductive material may comprise simultaneously rotating the tube of electrically conductive material about the mandrel and advancing the tube of electrically conductive material along the mandrel. Alternatively, the rotating and advancing the tube of electrically conductive material may comprise fixing the tube of electrically conductive material to the mandrel and rotating and advancing the mandrel relative to the fixed cutting device.

The cutting step may comprise cutting the helical aperture in only a portion of the tube of electrically conductive material to define a first end portion of the tube, a second end portion of the tube, and a central portion of the tube extending between the first end portion and the second end portion, wherein the helical aperture extends along only the central portion of the tube. In this case, the inductor coil comprises the first end portion of the tube, the second end portion of the tube, and the helical coil of electrically conductive material extending between the first end portion of the tube and the second end portion of the tube.

Advantageously, at least one of the first end portion of the tube and the second end portion of the tube may facilitate mounting of the inductor coil in an aerosol-generating device.

Preferably, each of the first end portion of the tube, the second end portion of the tube, and each turn of the helical coil has a maximum width extending in a direction parallel to a longitudinal axis of the tube, wherein the maximum width of each of the first end portion of the tube and the second end portion of the tube is greater than the maximum width of each turn of the helical coil.

The cutting step may further comprise cutting a plurality of discrete apertures in the tube of electrically conductive material. In embodiments in which the cutting step defines a first end portion of the tube and a second end portion of the tube, the cutting step may comprise cutting the plurality of discrete apertures in at least one of the first end portion of the tube of electrically conductive material and the second end portion of the tube of electrically conductive material.

Advantageously, the plurality of discrete apertures may facilitate the management of airflow through an aerosol-generating device comprising the inductor coil. For example, at least one of the discrete apertures may form an airflow opening.

Advantageously, the plurality of discrete apertures may reduce the weight of the inductor coil. Advantageously, the plurality of discrete apertures may reduce heat losses that may otherwise result from the conduction of heat from helical coil of electrically conductive material to the first and second end portions of the tube.

Preferably, the step of cutting a plurality of discrete apertures comprises cutting the plurality of discrete apertures in both of the first end portion of the tube of electrically conductive material and the second end portion of the tube of electrically conductive material.

The step of cutting a plurality of discrete apertures may comprise cutting the plurality of discrete apertures using at least one of a mechanical cutting process, electron discharge machining, and a laser cutter. Preferably, the step of cutting the plurality of discrete apertures comprises cutting the plurality of discrete apertures using a laser cutter. Preferably, the step of cutting the plurality of discrete apertures comprises the same cutting technique as the step of cutting the helical aperture.

The step of cutting the plurality of discrete apertures may be performed before, after, or concurrently with the step of cutting the helical aperture.

Preferably, the plurality of discrete apertures are distributed symmetrically in a circumferential direction extending around a longitudinal axis of the tube of electrically conductive material. The plurality of discrete apertures may be provided in to or more circumferentially extending rows.

Each of the discrete apertures may have any suitable shape. Each of the discrete apertures may have a circular shape, a triangular shape, a rectangular shape, a pentagonal shape, a hexagonal shape, a heptagonal shape, or an octagonal shape.

The method may comprise a step of providing a layer of electrically insulating material over a surface of the tube of electrically conductive material. Advantageously, the electrically insulating material may electrically isolate the inductor coil from other components of an aerosol-generating device and from an aerosol-generating article inserted into the inductor coil. Advantageously, an electrically insulating material may prevent electrical short circuit between adjacent windings of the inductor coil. Advantageously, the electrically insulating material may mechanically stabilise the inductor coil. For example, the electrically insulating material may reduce or eliminate a spring-like behaviour of the helical coil of electrically conductive material forming the inductor coil.

The layer of electrically insulating material may extend over at least a portion of an outer surface of the tube of electrically conductive material. The layer of electrically insulating material may extend over at least a portion of an inner surface of the tube of electrically conductive material. The layer of electrically insulating material may extend over at least a portion of each of the outer surface and the inner surface of the tube of electrically conductive material. The layer of electrically insulating material may extend over substantially the entire tube of electrically conductive material.

The step of providing a layer of electrically insulating material comprises wrapping a strip of the electrically insulating material around the outer surface of the tube of electrically conductive material. The wrapping step may comprise wrapping the strip of electrically insulating material in a helical shape around the outer surface of the tube of electrically conductive material. Preferably, the helical strip of electrically insulating material is wrapped around the outer surface of the tube of electrically conductive material in a first direction, wherein the helical aperture extends around the tube of electrically conductive material in a second direction, and wherein the second direction is opposite to the first direction.

The strip of electrically insulating material may comprise a polyimide film, such as Kapton.

The step of providing a layer of electrically insulating material may comprise overmoulding at least a portion of the tube of electrically conductive material with the electrically insulating material.

The electrically insulating material may comprise at least one of a polymer, a ceramic, and a glass. The electrically insulating material may comprise parylene.

The tube of electrically conductive material may have an inner surface, wherein the method comprises shaping at least one edge of the turns of the helical coil of electrically conductive material at the inner surface of the tube of electrically conductive material. Advantageously, shaping at least one edge of the turns of the helical coil of electrically conductive material may facilitate the insertion of an aerosol-generating article into the inductor coil.

The shaping step may comprise providing the at least one edge of the turns of the helical coil of electrically conductive material with a bevel, a chamfer or a fillet.

The shaping step may be carried out using any suitable process. The shaping step may comprise at least one of cutting and machining the at least one edge of the turns of the helical coil of electrically conductive material. The shaping step may comprise a milling process.

The shaping step may comprise shaping only one edge of the turns of the helical coil of electrically conductive material. Advantageously, shaping only one edge may facilitate insertion of an aerosol-generating article into the inductor coil and facilitate retention of the aerosol-generating article in the inductor coil. The un-shaped edge of each turn may resist removal of the aerosol-generating article from the inductor coil until the aerosol-generating article shrinks during use of the aerosol-generating system.

The method may comprise repeating at least the cutting step along a length of the tube of electrically conductive material to form a plurality of connected inductor coils along the tube of electrically conductive material. The method may comprise repeating any combination of steps described herein to form the plurality of connected inductor coils along the tube of electrically conductive material. Preferably, the method further comprises cutting the tube of electrically conductive material between consecutive connected inductor coils to form a plurality of separated inductor coils.

The helical aperture may have a number average width of at least 0.5 millimetres, or at least 1 millimetre, or at least 1.5 millimetres, or at least 2 millimetres. The helical aperture may have a number average width of less than 5 millimetres, or less than 4 millimetres, or less than 3 millimetres, or less than 2 millimetres.

The tube may be formed from any suitable electrically conductive material. Preferably, the tube is formed from a metal or a metal alloy. The tube may be formed from at least one of copper, a copper alloy, a copper-nickel alloy, tungsten, aluminium, an aluminium alloy, and a steel. Suitable steels include stainless steels, such as 316 stainless steels.

According to a second aspect of the disclosure there is provided an inductor coil formed using the method according to the first aspect of the disclosure, in accordance with any of the embodiments described herein.

According to a third aspect of the disclosure, there is provided an inductor coil for an aerosol-generating device, the inductor coil comprising a first tubular portion of electrically conductive material, a second tubular portion of electrically conductive material, and a helical coil of electrically conductive material extending between the first tubular portion of electrically conductive material and the second tubular portion of electrically conductive material.

The following optional and preferred features may be applied to inductor coils according to each of the second aspect of the disclosure and the third aspect of the disclosure.

Preferably, the helical coil is formed integrally with the first tubular portion and the second tubular portion.

Preferably, each of the first tubular portion, the second tubular portion, and each turn of the helical coil has a maximum width extending in a direction parallel to a longitudinal axis of the inductor coil, wherein the maximum width of each of the first tubular portion and the second tubular portion is greater than the maximum width of each turn of the helical coil.

The inductor coil may further comprise a plurality of discrete apertures in at least one of the first tubular portion of electrically conductive material and the second tubular portion of electrically conductive material.

Advantageously, the plurality of discrete apertures may facilitate the management of airflow through an aerosol-generating device comprising the inductor coil. For example, at least one of the discrete apertures may form an airflow opening.

Advantageously, the plurality of discrete apertures may reduce the weight of the inductor coil. Advantageously, the plurality of discrete apertures may reduce heat losses that may otherwise result from the conduction of heat from helical coil of electrically conductive material to the first and second end portions of the tube.

The inductor coil may comprise the plurality of discrete apertures in both the first tubular portion of electrically conductive material and the second tubular portion of electrically conductive material.

Preferably, the plurality of discrete apertures are distributed symmetrically in a circumferential direction extending around a longitudinal axis of the tube of electrically conductive material. The plurality of discrete apertures may be provided in to or more circumferentially extending rows.

Each of the discrete apertures may have any suitable shape. Each of the discrete apertures may have a circular shape, a triangular shape, a rectangular shape, a pentagonal shape, a hexagonal shape, a heptagonal shape, or an octagonal shape.

The inductor coil may comprise a layer of electrically insulating material extending over a surface of at least one of the first tubular portion, the second tubular portion and the helical coil.

Advantageously, the electrically insulating material may electrically isolate the inductor coil from other components of an aerosol-generating device and from an aerosol-generating article inserted into the inductor coil. Advantageously, an electrically insulating material may prevent electrical short circuit between adjacent windings of the inductor coil. Advantageously, the electrically insulating material may mechanically stabilise the inductor coil. For example, the electrically insulating material may reduce or eliminate a spring-like behaviour of the helical coil of electrically conductive material forming the inductor coil.

The layer of electrically insulating material may extend over a surface of the first tubular portion, the second tubular portion, and the helical coil. The layer of electrically insulating material may extend over an outer surface of the first tubular portion, the second tubular portion, and the helical coil. The layer of electrically insulating material may extend over an inner surface of the first tubular portion, the second tubular portion, and the helical coil. The layer of electrically insulating material may extend over substantially the entire first tubular portion, the entire second tubular portion, and the entire helical coil.

The layer of electrically insulating material may comprise a strip of the electrically insulating material wrapped around the outer surface of the first tubular portion, the second tubular portion and the helical coil. The strip of electrically insulating material may be wrapped in a helical shape around the outer surface of the first tubular portion, the second tubular portion and the helical coil. Preferably, the helical strip of electrically insulating material is wrapped around the outer surface of the first tubular portion, the second tubular portion and the helical coil in a first direction, wherein the helical coil is turned in a second direction, and wherein the second direction is opposite to the first direction.

The strip of electrically insulating material may comprise a polyimide film, such as Kapton.

The layer of electrically insulating material may be overmoulded over at least a portion of the first tubular portion, the second tubular portion and the helical coil.

The electrically insulating material may comprise at least one of a polymer, a ceramic, and a glass. The electrically insulating material may comprise parylene.

Preferably, the helical coil of electrically conductive material has an inner surface, wherein at least one edge of the turns of the helical coil comprises a bevel, a chamfer or a fillet. Advantageously, providing at least one edge of the turns of the helical coil with a bevel, a chamfer or a fillet may facilitate the insertion of an aerosol-generating article into the inductor coil. Preferably, only one edge of each turn comprises a bevel, a chamfer or a fillet. Advantageously, providing only one edge of each turn with a bevel, a chamfer or a fillet may facilitate insertion of an aerosol-generating article into the inductor coil and facilitate retention of the aerosol-generating article in the inductor coil. The edge of each turn without a bevel, a chamfer or a fillet may resist removal of the aerosol-generating article from the inductor coil until the aerosol-generating article shrinks during use of the aerosol-generating system.

The helical coil may define a helical aperture extending between the turns of the helical coil. The helical aperture may have a number average width of at least 0.5 millimetres, or at least 1 millimetre, or at least 1.5 millimetres, or at least 2 millimetres. The helical aperture may have a number average width of less than 5 millimetres, or less than 4 millimetres, or less than 3 millimetres, or less than 2 millimetres.

The first tubular portion, the second tubular portion and the helical coil may be formed from any suitable electrically conductive material. Preferably, the electrically conductive material is a metal or a metal alloy. The electrically conductive material may be at least one of copper, a copper alloy, a copper-nickel alloy, tungsten, aluminium, an aluminium alloy, and a steel. Suitable steels include stainless steels, such as 316 stainless steels.

According to a fourth aspect of the disclosure, there is provided an aerosol-generating device comprising an inductor coil according to the second or third aspect of the disclosure, in accordance with any of the embodiments described herein. The aerosol-generating device also comprises a chamber for receiving at least a portion of an aerosol-generating article. The aerosol-generating device also comprises a power supply and control circuitry connected to the inductor coil and configured to provide an alternating electric current to the inductor coil such that, in use, the inductor coil generates an alternating magnetic field.

Preferably, the inductor coil is positioned within the chamber so that an aerosol-generating article inserted into the chamber is received within the inductor coil.

Advantageously, positioning the inductor coil inside the chamber may facilitate the transfer of resistively generated heat from the inductor coil to an aerosol-forming substrate of an aerosol-generating article received within the chamber. In embodiments in which the inductor coil is used to inductively heat a susceptor material or element positioned inside an aerosol-forming substrate, advantageously, the inductive heating of the susceptor element and the resistive heating of the inductor coil may provide simultaneous internal and external heating of the aerosol-forming substrate. Advantageously, simultaneous internal and external heating of the aerosol-forming substrate may facilitate more uniform heating of the aerosol-forming substrate.

The inductor coil may be suspended within the chamber.

The term “suspended” is used herein to refer to arrangements in which less than 50 percent of an outer surface of the inductor coil contacts an inner surface of the chamber. Advantageously, suspending the inductor coil inside the chamber may reduce or minimise the transfer of resistively generated heat from the inductor coil to other components of the aerosol-generating device. Advantageously, reducing or minimising the transfer of resistively generated heat from the inductor coil to other components of the aerosol-generating device may increase or maximise the transfer of resistively generated heat from the inductor coil to an aerosol-forming substrate.

Preferably, less than 40 percent of the outer surface of the inductor coil contacts the inner surface of the chamber. Preferably, less than 30 percent of the outer surface of the inductor coil contacts the inner surface of the chamber. Preferably, less than 20 percent of the outer surface of the inductor coil contacts the inner surface of the chamber. Preferably, less than 10 percent of the outer surface of the inductor coil contacts the inner surface of the chamber. Preferably, less than 5 percent of the outer surface of the inductor coil contacts the inner surface of the chamber. Preferably, the chamber comprises an open first end through which at least a portion of an aerosol-generating article may be inserted into the chamber and a closed second end opposite the open first end.

The chamber may comprise a substantially cylindrical inner surface. Preferably, the outer surface of the inductor coil is spaced apart from the cylindrical inner surface of the chamber. Advantageously, the space between the outer surface of the inductor coil and the cylindrical inner surface of the chamber reduces or minimises conductive heat transfer from the inductor coil to other components of the aerosol-generating device.

Preferably, the aerosol-generating device further comprises an airflow channel defined between the cylindrical inner surface of the chamber and the outer surface of the inductor coil, wherein the airflow channel provides fluid communication between the first end of the chamber and the second end of the chamber.

Advantageously, using the space between the cylindrical inner surface of the chamber and the outer surface of the inductor coil as an airflow channel may eliminate the need to provide a more complex airflow arrangement within the chamber. For example, the cylindrical inner surface of the chamber may have a substantially smooth and continuous surface.

Advantageously, using the space between the cylindrical inner surface of the chamber and the outer surface of the inductor coil as an airflow channel may further reduce or minimise the transfer of heat from the inductor coil to other components of the aerosol-generating device. Advantageously, heat losses from the outer surface of the inductor coil may be absorbed by airflow through the airflow channel so that the heated airflow is received by an aerosol-forming substrate received within the chamber.

Preferably, the annular gap has a number average width in a radial direction of at least 0.5 millimetres, or at least 1 millimetre, or at least 1.5 millimetres, or at least 2 millimetres. Preferably, the annular gap has a number average width in a radial direction of less than 5 millimetres, or less than 4 millimetres, or less than 3 millimetres, or less than 2 millimetres.

Preferably, the aerosol-generating device comprises a pressure sensor in fluid communication with the airflow channel defined by the annular gap. Advantageously, the relatively narrow airflow channel defined by the annular gap may amplify a pressure drop created when a user draws on an aerosol-generating system comprising the aerosol-generating device. Advantageously, the amplified pressure drop may increase the sensitivity of the pressure sensor to puffing by the user.

Preferably, the pressure sensor is configured to provide a signal to the control circuitry indicative of a user drawing on an aerosol-generating system comprising the aerosol-generating device.

Preferably, the aerosol-generating device comprises at least one protrusion extending into the chamber from the closed second end of the chamber. Advantageously, the at least one protrusion may abut an upstream end of an aerosol-generating article received within the chamber to space the upstream end of the aerosol-generating article apart from the closed end of the chamber. Advantageously, spacing the upstream end of the aerosol-generating article from the closed end of the chamber may facilitate airflow into the aerosol-generating article during use.

The aerosol-generating device may comprise a housing, wherein the inductor coil, the power supply and the control circuitry are positioned within the housing. Preferably, the housing comprises an end wall defining the closed second end of the chamber, wherein the at least one protrusion extends into the chamber from the end wall. Preferably, the at least one protrusion is formed integrally with the end wall.

Preferably, the at least one protrusion comprises at least three protrusions. Advantageously, providing at least three protrusions may facilitate secure and correct positioning of an aerosol-generating article in the chamber. Preferably, the chamber has a longitudinal axis defining a first direction along which at least a portion of an aerosol-generating article may be inserted into the chamber, wherein the at least three protrusions are equidistantly spaced from each other in a circumferential direction around the longitudinal axis.

The aerosol-generating device may comprise a susceptor element. Advantageously, providing a susceptor element as part of the aerosol-generating device may eliminate the need to provide each aerosol-generating article with a susceptor element. Advantageously, this may reduce the cost of each aerosol-generating article.

As used herein, the term “susceptor element” refers to an element comprising a material that is capable of converting the energy of a magnetic field into heat. When a susceptor element is located in an alternating magnetic field, the susceptor is inductively heated. Heating of the susceptor may be the result of at least one of hysteresis losses and eddy currents induced in the susceptor, depending on the electrical and magnetic properties of the susceptor material.

Preferably, the susceptor element is an elongate susceptor element. Preferably, the elongate susceptor element extends into the chamber from the closed second end of the chamber. Preferably, at least a portion of the elongate susceptor element is positioned inside the inductor coil.

The susceptor element may be formed from any material that can be inductively heated to a temperature sufficient to aerosolise an aerosol-forming substrate. Suitable materials for the susceptor element include graphite, molybdenum, silicon carbide, stainless steels, niobium, and aluminium. Preferred susceptor elements comprise a metal or carbon. Preferably, the susceptor element comprises or consists of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than about 20 percent, more preferably more than about 50 percent or more than 90 percent of ferromagnetic or paramagnetic materials. Preferred susceptor elements may be heated to a temperature in excess of about 250 degrees Celsius.

The susceptor element may comprise a non-metallic core with a metal layer disposed on the non-metallic core. For example, the susceptor element may comprise one or more metallic tracks formed on an outer surface of a ceramic core or substrate.

The susceptor element may have a protective external layer, for example a protective ceramic layer or protective glass layer. The protective external layer may encapsulate the susceptor element. The susceptor element may comprise a protective coating formed by a glass, a ceramic, or an inert metal, formed over a core of susceptor material.

The susceptor element may have any suitable cross-section. For example, the susceptor element may have a square, oval, rectangular, triangular, pentagonal, hexagonal, or similar cross-sectional shape. The susceptor element may have a planar or flat cross-sectional shape.

The susceptor element may be solid, hollow, or porous. Preferably, the susceptor element is solid.

In embodiments in which the susceptor element has a planar or flat cross-sectional shape, preferably the susceptor element has a thickness of between about 1 millimetre and about 8 millimetres, more preferably from about 3 millimetres to about 5 millimetres. The thickness of the susceptor element is measured in a longitudinal direction of the aerosol-generating device. Preferably, the susceptor element has a width or a diameter of between about 3 millimetres and about 12 millimetres, more preferably between about 4 millimetres and about 10 millimetres, more preferably between about 5 millimetres and about 8 millimetres. The width or diameter of the susceptor element is orthogonal to its thickness.

In embodiments in which the susceptor element is an elongate susceptor element, preferably the elongate susceptor element is in the form of a pin, rod, blade, or plate. Preferably, the elongate susceptor element has a length of between about 5 millimetres and about 15 millimetres, for example between about 6 millimetres and about 12 millimetres, or between about 8 millimetres and about 10 millimetres. The elongate susceptor element preferably has a width of between about 1 millimetre and about 8 millimetres, more preferably from about 3 millimetres to about 5 millimetres. The elongate susceptor element may have a thickness of from about 0.01 millimetres to about 2 millimetres. If the elongate susceptor element has a constant cross-section, for example a circular cross-section, it has a preferable width or diameter of between about 1 millimetre and about 5 millimetres.

Preferably, the inductor coil is arranged so that, when an aerosol-generating article is inserted into the chamber, at least part of the aerosol-generating article is received within the inductor coil. Preferably, the inductor coil is arranged so that, when an aerosol-generating article is inserted into the chamber, the inductor coil directly contacts the aerosol-generating article. Advantageously, direct contact between the inductor coil and an aerosol-generating article facilitates the conductive transfer of resistively generated heat from the inductor coil to the aerosol-generating article.

The power supply may be a DC power supply. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

The power supply may be configured to operate at high frequency. As used herein, the term “high frequency oscillating current” means an oscillating current having a frequency of between about 500 kilohertz and about 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The aerosol-generating device comprises control circuitry connected to the inductor coil and the power supply. The control circuitry is configured to control the supply of power to the inductor coil from the power supply. The control circuitry may comprise a microprocessor, which may be a programmable microprocessor, a microcontroller, or an application specific integrated chip (ASIC) or other electronic circuitry capable of providing control. The control circuitry may comprise further electronic components. The control circuitry may be configured to regulate a supply of current to the inductor coil. Current may be supplied to the inductor coil continuously following activation of the aerosol-generating device or may be supplied intermittently, such as on a puff by puff basis. The control circuitry may advantageously comprise DC/AC inverter, which may comprise a Class-D or Class-E power amplifier.

The control circuitry may be configured to supply electric energy from the power supply to the inductor coil as an alternating current such that the inductor coil is operable to generate heat through one or a combination of i) resistive heating of the inductor coil and ii) heating of a susceptor element through inductive coupling of the inductor coil with the susceptor. The control circuitry may be configured to adjust at least one parameter of the alternating current to change the inductive coupling of the inductor coil with the susceptor element, thereby adjusting the balance of heat generated through inductive coupling of the inductor coil with the susceptor element relative to heat generated through resistive heating of the inductor coil.

As used herein, the term “inductively couple” refers to the heating of a susceptor element when penetrated by an alternating magnetic field. The heating may be caused by the generation of eddy currents in the susceptor element. The heating may be caused by magnetic hysteresis losses.

Preferably, the at least one parameter comprises a frequency of the alternating current. The inductive coupling between the inductor coil and susceptor element varies with changes in the frequency of the alternating current. The frequency may be adjusted to have a value f_{susceptor}, associated with an alternating current creating an alternating magnetic field that provides optimum coupling with the susceptor element to allow transfer of almost the totality of the energy from the inductor coil to the susceptor element, resulting in most of the heat being generated by inductive heating of the susceptor element. The frequency may also be adjusted to have a value f_{inductor} coil, associated with an alternating current creating an alternating magnetic field that provides little to no coupling with the susceptor element and allows almost the totality of the energy to remain within the inductor coil, resulting in most of the heat being generated by resistive heating of the inductor coil. The frequency may also be adjusted to have a value fₜₒₜₐₗ, associated with an alternating current which results in a combination of inductive heating of the susceptor element and resistive heating of the inductor coil. Each of these frequencies will vary depending on the materials, physical properties and configuration of the inductor coil and the susceptor element, such as the inductance of the inductor coil and the magnetic permeability of the material or materials from which the susceptor element is formed.

The control circuitry may be configured to provide an alternating current to the inductor coil, such that the inductor coil generates an alternating magnetic field to inductively heat a susceptor element in an aerosol-generating article, and to provide a direct current to the inductor coil to resistively heat the inductor coil and thereby conductively heat the aerosol-generating article. Advantageously, using a single coil to provide both heating power to an internal susceptor and to provide resistive heating of the coil itself provides two different heat sources in different locations relative to the aerosol-forming substrate with a structure that is no more complex than a typical induction heating arrangement.

The control circuitry may be configured to adjust the alternating current provided to the inductor coil during operation of the aerosol-generating device to adjust an amount of heating provided by inductive heating.

The control circuitry may be configured to adjust the direct current provided to the inductor coil during operation of the aerosol-generating device to adjust an amount of heating provided by resistive heating.

The control circuitry may be configured to provide the alternating current and the direct current to the inductor coil at different times. For example, following activation of the aerosol-generating device the control circuitry may be configured to initially provide alternating current to the inductor coil and to subsequently provide direct current to the inductor coil. This may provide for rapid generation of aerosol at the outset of a usage session, but also provide for complete and efficient heating of the entire aerosol-forming substrate over a full usage session. At the beginning of a usage session, inductive heating of an internal susceptor may provide aerosol more quickly than external resistive heating because the susceptor can be in closer contact with the aerosol-forming substrate. An internal susceptor may also be heated more quickly than the external inductor coil if the susceptor has a lower thermal mass than the inductor coil.

The control circuitry may be configured to provide the alternating current and the direct current to the inductor coil in an alternating sequence. It may be beneficial to alternate external and internal heating in order to avoid overheating of any part of the aerosol-forming substrate.

The control circuitry may be configured to provide both alternating current and direct current to the inductor coil concurrently. In this way a larger amount of heat energy can be transferred to the aerosol-forming substrate to generate a larger volume of aerosol, without either the susceptor or the inductor coil reaching a temperature at which any part of the aerosol-generating article might combust.

An aerosol-generating device comprising control circuitry configured to vary at least one parameter of an alternating electric current, or configured to provide both alternating current and direct current to the inductor coil, is able to change the mode of application of heat to an aerosol-forming substate according to any one of the following heating regimes:
a) solely or predominantly through the resistive heating of the inductor coil;
b) solely or predominantly through heating of a susceptor element through the inductive coupling of the inductor coil with the susceptor element;
c) a combination of resistive heating of the inductor coil and heating of a susceptor element through the inductive coupling of the inductor coil with the susceptor element.

Preferably, the aerosol-generating device is portable. The aerosol-generating device may have a size comparable to a conventional cigar or cigarette. The aerosol-generating device may have a total length between approximately 30 millimetres and approximately 150 millimetres. The aerosol-generating device may have an external diameter between approximately 5 millimetres and approximately 30 millimetres.

The aerosol-generating device housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise a mouthpiece. The mouthpiece may comprise at least one air inlet and at least one air outlet. The mouthpiece may comprise more than one air inlet. One or more of the air inlets may reduce the temperature of the aerosol before it is delivered to a user and may reduce the concentration of the aerosol before it is delivered to a user.

Alternatively, the mouthpiece may be provided as part of an aerosol-generating article.

As used herein, the term “mouthpiece” refers to a portion of an aerosol-generating device that is placed into a user's mouth in order to directly inhale an aerosol generated by the aerosol-generating device from an aerosol-generating article received in the chamber of the housing.

The aerosol-generating device may include a user interface to activate the device, for example a button to initiate heating of the device or display to indicate a state of the device or of the aerosol-forming substrate.

According to a fifth aspect of the disclosure there is provided an aerosol-generating system. The aerosol-generating system comprises an aerosol-generating device according to the fourth aspect of the disclosure, in accordance with any of the embodiments described herein. The aerosol-generating system also comprises an aerosol-generating article comprising an aerosol-forming substrate.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-forming substrate” refers to a substrate consisting of or comprising an aerosol-forming material that is capable of releasing volatile compounds upon heating to generate an aerosol.

The aerosol-generating article may comprise an article susceptor element. Preferably, the article susceptor element is positioned in direct contact with the aerosol-forming substrate. Preferably, the article susceptor element is an internal susceptor element positioned within the aerosol-forming substrate.

Preferably, the aerosol-generating article is configured so that at least a portion of the article susceptor element is positioned within the inductor coil when the aerosol-generating article is inserted into the chamber of the aerosol-generating device.

The article susceptor element may comprise any of the optional or preferred features described above with respect to a susceptor element forming part of the aerosol-generating device.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The invention is defined in the claims. However, below there is provided a non-exhaustive list of non-limiting examples. Any one or more of the features of these examples may be combined with any one or more features of another example, embodiment, or aspect described herein.

Example 1: A method of forming an inductor coil for an aerosol-generating device, the method comprising:
providing a tube of electrically conductive material; and
cutting a helical aperture in at least a portion of the tube of electrically conductive material to define a helical coil of the electrically conductive material, the helical coil of the electrically conductive material forming an inductor coil for an aerosol-generating device.

Example 2: The method of Example 1, wherein the step of cutting a helical aperture comprises rotating and advancing the tube of electrically conductive material relative to a fixed cutting device.

Example 3: The method of Example 1 or 2, wherein the step of providing a tube of electrically conductive material comprises positioning the tube of electrically conductive material on a mandrel.

Example 4: The method of Examples 2 and 3, wherein the rotating and advancing the tube of electrically conductive material comprises simultaneously rotating the tube of electrically conductive material about the mandrel and advancing the tube of electrically conductive material along the mandrel.

Example 5: The method of any preceding Example, wherein the cutting step comprises cutting the helical aperture in only a portion of the tube of electrically conductive material to define a first end portion of the tube, a second end portion of the tube, and a central portion of the tube extending between the first end portion and the second end portion, and wherein the helical aperture extends along only the central portion of the tube so that the inductor coil comprises the first end portion of the tube, the second end portion of the tube, and the helical coil of electrically conductive material extending between the first end portion of the tube and the second end portion of the tube.

Example 6: The method of Example 5, wherein each of the first end portion of the tube, the second end portion of the tube, and each turn of the helical coil has a maximum width extending in a direction parallel to a longitudinal axis of the tube, and wherein the maximum width of each of the first end portion of the tube and the second end portion of the tube is greater than the maximum width of each turn of the helical coil.

Example 7: The method of Example 5 or 6, wherein the cutting step further comprises cutting a plurality of discrete apertures in at least one of the first end portion of the tube of electrically conductive material and the second end portion of the tube of electrically conductive material.

Example 8: The method of Example 7, wherein the step of cutting a plurality of discrete apertures comprises cutting the plurality of discrete apertures in both of the first end portion of the tube of electrically conductive material and the second end portion of the tube of electrically conductive material.

Example 9: The method of Example 7 or 8, wherein the plurality of discrete apertures are distributed symmetrically in a circumferential direction extending around a longitudinal axis of the tube of electrically conductive material.

Example 10: The method of Example 7, 8 or 9, wherein each of the discrete apertures has a circular shape, a triangular shape, a rectangular shape, a pentagonal shape, a hexagonal shape, a heptagonal shape, or an octagonal shape.

Example 11: The method of any preceding Example, further comprising a step of providing a layer of electrically insulating material around an outer surface of the tube of electrically conductive material.

Example 12: The method of Example 11, wherein the step of providing a layer of electrically insulating material comprises wrapping a strip of the electrically insulating material around the outer surface of the tube of electrically conductive material.

Example 13: The method of Example 12, wherein the wrapping step comprises wrapping the strip of electrically insulating material in a helical shape around the outer surface of the tube of electrically conductive material.

Example 14: The method of Example 13, wherein the helical strip of electrically insulating material is wrapped around the outer surface of the tube of electrically conductive material in a first direction, wherein the helical aperture extends around the tube of electrically conductive material in a second direction, and wherein the second direction is opposite to the first direction.

Example 15: The method of Example 11, wherein the step of providing a layer of electrically insulating material comprises overmoulding the outer surface of the tube of electrically conductive material with the electrically insulating material.

Example 16: The method of any preceding Example, wherein the tube of electrically conductive material has an inner surface, the method further comprising shaping at least one edge of the turns of the helical coil of electrically conductive material at the inner surface of the tube of electrically conductive material.

Example 17: The method of Example 16, wherein the shaping step comprises providing the at least one edge of the turns of the helical coil of electrically conductive material with a bevel, a chamfer or a fillet.

Example 18: The method of Example 16 or 17, wherein the shaping step comprises at least one of cutting and machining the at least one edge of the turns of the helical coil of electrically conductive material.

Example 19: The method of any preceding Example, wherein the cutting step comprises cutting the tube of electrically conductive material using a laser cutter.

Example 20: The method of any preceding Example, further comprising repeating at least the cutting step along a length of the tube of electrically conductive material to form a plurality of connected inductor coils along the tube of electrically conductive material.

Example 21: The method of Example 20, further comprising cutting the tube of electrically conductive material between consecutive connected inductor coils to form a plurality of separated inductor coils.

Example 22: An inductor coil formed using the method according to any preceding Example.

Example 23: An inductor coil for an aerosol-generating device, the inductor coil comprising:
a first tubular portion of electrically conductive material;
a second tubular portion of electrically conductive material; and
a helical coil of electrically conductive material extending between the first tubular portion of electrically conductive material and the second tubular portion of electrically conductive material.

Example 24: The inductor coil of Example 23, wherein the helical coil is formed integrally with the first tubular portion and the second tubular portion.

Example 25: The inductor coil of Example 23 or 24, wherein each of the first tubular portion, the second tubular portion, and each turn of the helical coil has a maximum width extending in a direction parallel to a longitudinal axis of the inductor coil, and wherein the maximum width of each of the first tubular portion and the second tubular portion is greater than the maximum width of each turn of the helical coil.

Example 26: The inductor coil of Example 23, 24 or 25, further comprising a plurality of discrete apertures in at least one of the first tubular portion of electrically conductive material and the second tubular portion of electrically conductive material.

Example 27: The inductor coil of Example 26, further comprising the plurality of discrete apertures in both the first tubular portion of electrically conductive material and the second tubular portion of electrically conductive material.

Example 28: The inductor coil of Example 26 or 27, wherein the plurality of discrete apertures are distributed symmetrically in a circumferential direction extending around a longitudinal axis of the inductor coil.

Example 29: The inductor coil of Example 26, 27 or 28, wherein each of the discrete apertures has a circular shape, a triangular shape, a rectangular shape, a pentagonal shape, a hexagonal shape, a heptagonal shape, or an octagonal shape.

Example 30: The inductor coil of any of Examples 23 to 29, further comprising a layer of electrically insulating material extending around an outer surface of the first tubular portion, the second tubular portion and the helical coil.

Example 31: The inductor coil of Example 30, wherein the layer of electrically insulating material comprises a strip of the electrically insulating material extending around the outer surface of the first tubular portion, the second tubular portion and the helical coil.

Example 32: The inductor coil of Example 31, wherein the strip of electrically insulating material extends in a helical shape around the outer surface of the first tubular portion, the second tubular portion and the helical coil.

Example 33: The inductor coil of Example 32, wherein the helical strip of electrically insulating material is wound in a first direction, wherein the helical coil turns in a second direction, and wherein the second direction is opposite to the first direction.

Example 34: The inductor coil of Example 30, wherein the layer of electrically insulating is overmoulded on the outer surface of the first tubular portion, the second tubular portion and the helical coil.

Example 35: The inductor coil of any of Examples 23 to 34, wherein the helical coil of electrically conductive material has an inner surface, and wherein at least one edge of the turns of the helical coil comprises a bevel, a chamfer or a fillet.

Example 36: An aerosol-generating device comprising:
an inductor coil according to any of Examples 22 to 35;
a chamber for receiving at least a portion of an aerosol-generating article; and
a power supply and control circuitry connected to the inductor coil and configured to provide an alternating electric current to the inductor coil such that, in use, the inductor coil generates an alternating magnetic field.

Example 37: An aerosol-generating device according to Example 36, wherein the chamber comprises an open first end through which at least a portion of an aerosol-generating article may be inserted into the chamber and a closed second end opposite the open first end.

Example 38: An aerosol-generating device according to the Example 37, further comprising at least one protrusion extending into the chamber from the closed second end of the chamber.

Example 39: An aerosol-generating device according to Example 38, wherein the at least one protrusion comprises at least three protrusions.

Example 40: An aerosol-generating device according to Example 39, wherein the chamber has a longitudinal axis defining a first direction along which at least a portion of an aerosol-generating article may be inserted into the chamber, and wherein the at least three protrusions are equidistantly spaced from each other in a circumferential direction around the longitudinal axis.

Example 41: An aerosol-generating device according to any of Examples 36 to 40, further comprising a housing, wherein the inductor coil, the power supply and the control circuitry are positioned within the housing.

Example 42: An aerosol-generating device according to the combination of Example 41 with any of Examples 37 to 40, wherein the housing comprises an end wall defining the closed second end of the chamber, and wherein the at least one protrusion extends into the chamber from the end wall.

Example 43: An aerosol-generating device according to Example 42, wherein the at least one protrusion is formed integrally with the end wall.

Example 44: An aerosol-generating device according to any of Examples 37 to 43, further comprising an elongate susceptor element extending into the chamber from the closed second end of the chamber.

Example 45: An aerosol-generating device according to Example 44, wherein at least a portion of the elongate susceptor element is positioned inside the inductor coil.

Example 46: An aerosol-generating device according to any of Examples 36 to 45, wherein the inductor coil is arranged so that, when an aerosol-generating article is inserted into the chamber, at least part of the aerosol-generating article is received within the inductor coil.

Example 47: An aerosol-generating system comprising: an aerosol-generating device according to any of Examples 36 to 46; and an aerosol-generating article comprising an aerosol-forming substrate.

Example 48: An aerosol-generating system according to Example 47, wherein the aerosol-generating article further comprises an article susceptor element.

Example 49: An aerosol-generating system according to Example 48, wherein the aerosol-generating article is configured so that at least a portion of the article susceptor element is positioned within the inductor coil when the aerosol-generating article is inserted into the chamber.

The invention is further described, by way of example only, with reference to the accompanying drawings in which:

FIG. 1 shows a side cross-sectional view of an aerosol-generating device comprising an inductor coil according to a first embodiment of the present invention;

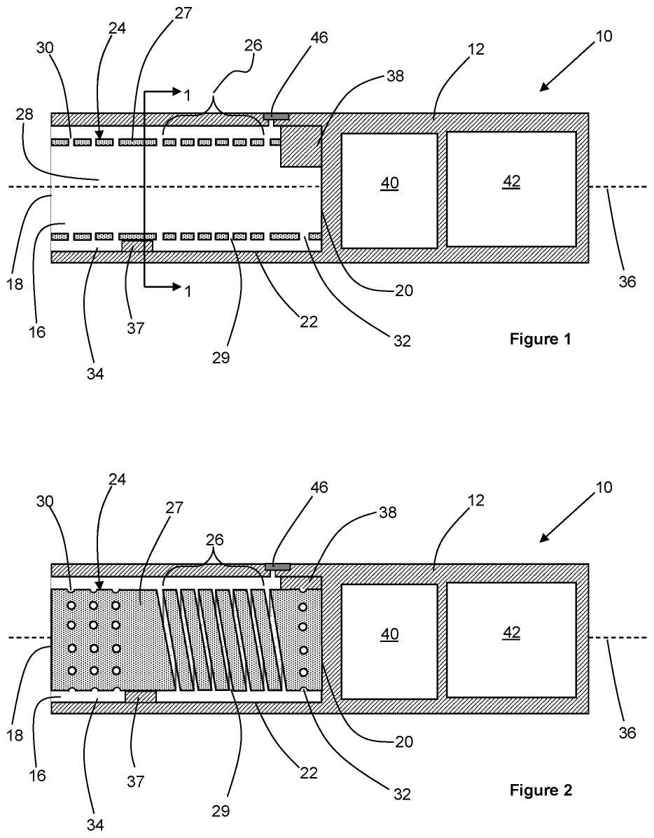

FIG. 2 shows a partial cut-away view of the aerosol-generating device of FIG. 1 to illustrate an external surface of the inductor coil;

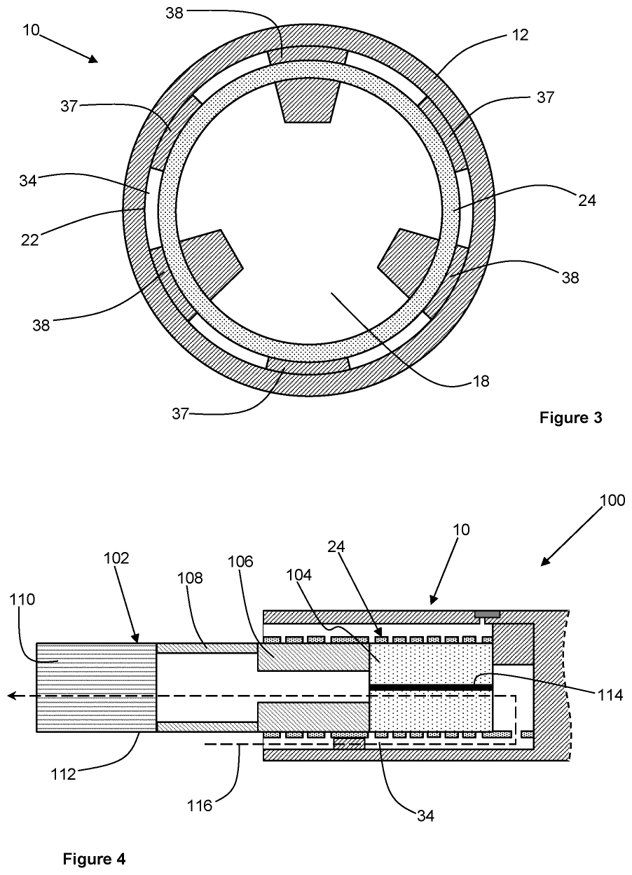

FIG. 3 shows an axial cross-sectional view of the aerosol-generating device of FIG. 1 along line 1-1;

FIG. 4 shows a side cross-sectional view of an aerosol-generating system comprising the aerosol-generating device of FIG. 1;

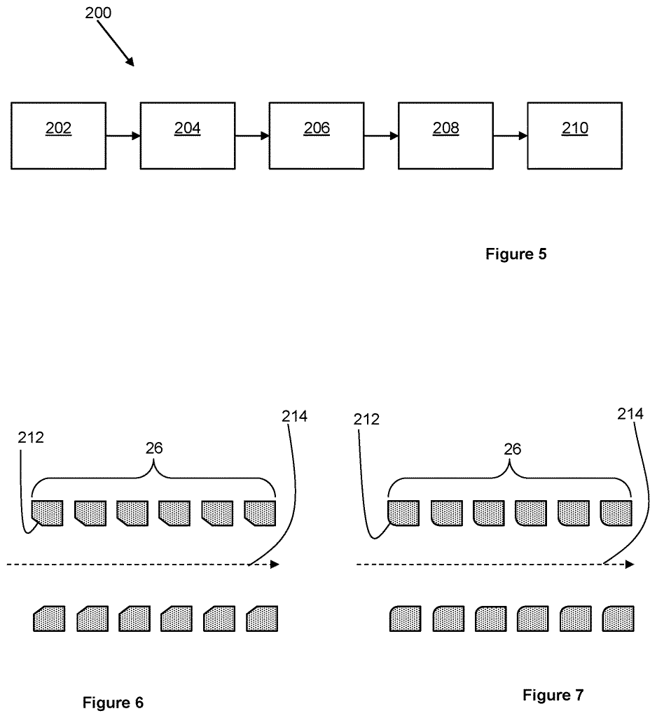

FIG. 5 shows a flow diagram illustrating a method of forming an inductor coil according to an embodiment of the present invention;

FIG. 6 shows a cross-sectional view of the windings of the inductor coil of FIG. 1 and illustrating a first arrangement of the windings;

FIG. 7 shows a cross-sectional view of the windings of the inductor coil of FIG. 1 and illustrating a second arrangement of the windings;

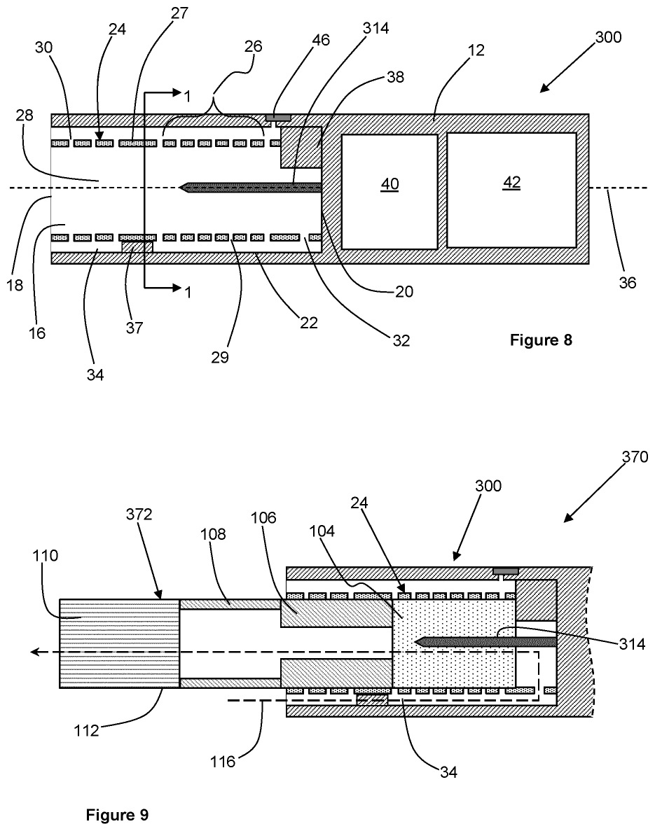

FIG. 8 shows a side cross-sectional view of an aerosol-generating device according to a second embodiment of the present invention;

FIG. 9 shows a side cross-sectional view of an aerosol-generating system comprising the aerosol-generating device of FIG. 8;

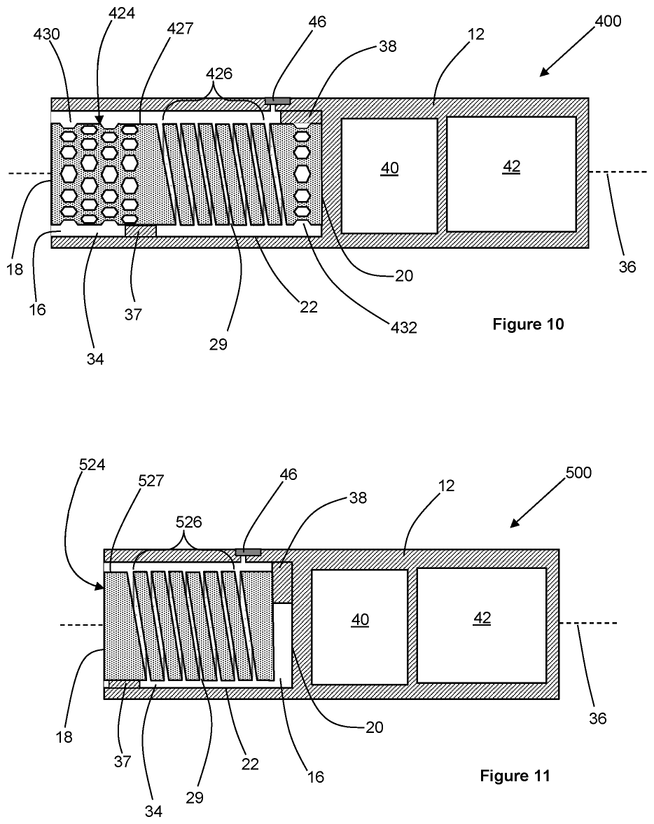

FIG. 10 shows a side cross-sectional view of an aerosol-generating device according to a third embodiment of the present invention; and

FIG. 11 shows a side cross-sectional view of an aerosol-generating device according to a fourth embodiment of the present invention.

FIGS. 1 to 3 show an aerosol-generating device 10 in accordance with a first embodiment of the present invention. The aerosol-generating device 10 comprises a housing 12 defining a chamber 16 for receiving a portion of an aerosol-generating article. The chamber 16 comprises an open end 18 through which an aerosol-generating article may be inserted into the chamber 16 and a closed end 20 opposite the open end 18. A cylindrical wall 22 of the chamber 16 extends between the open end 18 and the closed end 20.

The aerosol-generating device 10 also comprises an inductor coil 24 comprising a plurality of windings 26 disposed within the chamber 16. The inductor coil 24 is formed from an electrically conductive metal tube 27 into which a helical aperture 29 has been formed to define the plurality of windings 26. The plurality of windings 26 form a helical coil of electrically conductive material that extends between a first tubular portion of electrically conductive material formed by a first end of the metal tube 27 and a second tubular portion of electrically conductive material formed by a second end of the metal tube 27. The metal tube 27 defines a lumen 28 in which a portion of an aerosol-generating article is received when the aerosol-generating article is inserted into the chamber 16. Advantageously, positioning the inductor coil 24 in direct contact with an aerosol-generating article received within the chamber 16 facilitates the transfer of heat generated by resistive heating of the inductor coil 24 to the aerosol-generating article.

The metal tube 27 comprises a plurality of cut-outs 30 at the first end of the metal tube 27 positioned towards the open end 18 of the chamber 16. Therefore, the plurality of cut-outs 30 extend through the first tubular portion of electrically conductive material. Advantageously, the plurality of cut-outs 30 reduce the weight of the inductor coil 24 and reduce heat losses that may result from the conduction of heat from the windings 26 to the first end of the metal tube 27.

The metal tube 27 also comprises a plurality of airflow apertures 32 at the second end of the metal tube 27 positioned towards the closed end 20 of the chamber 16. Therefore, the plurality of airflow apertures 32 extend through the second tubular portion of electrically conductive material. Advantageously, the plurality of airflow apertures 32 provide fluid communication between the outside and the inside of the metal tube 27, as will be further described below.

The housing 12 defines a plurality of first protrusions 37 and a plurality of second protrusions 38 each extending into the chamber 16. Advantageously, the first and second protrusions 37, 38 support the metal tube 27 in the chamber 16 so that the inductor coil 24 is arranged coaxially with a central axis 36 of the aerosol-generating device 10. Advantageously, arranging the inductor coil to extend concentrically about the central axis 36 of the aerosol-generating device 10 facilitates the insertion of an aerosol-generating article into the chamber 16. Furthermore, the first and second protrusions 37, 38 position the metal tube 27 so that an outer surface of the metal tube 27 is spaced apart from the cylindrical wall 22 of the chamber 16. Spacing an outer surface of the metal tube 27 from the cylindrical wall 22 of the chamber 16 defines an annular gap 34 between the cylindrical wall 22 of the chamber 16 and the outer surface of the metal tube 27. Advantageously, the annular gap 34 reduces or minimises the transfer of heat generated by resistive heating of the inductor coil 24 to the housing 12. Advantageously, the annular gap 34 facilitates airflow through the chamber 16 when an aerosol-generating article is received within the chamber 16.

The plurality of first protrusions 37 contact an outer surface of the metal tube 27. Each of the plurality of second protrusions 38 is received within a corresponding slot defined by the second end of the metal tube 27. As will be further described below, the plurality of second protrusions 38 also function to maintain a gap between an end of an aerosol-generating article and the closed end 20 of the chamber 16 when the aerosol-generating article is fully inserted into the chamber 16. In the embodiment shown in FIGS. 1 to 3, the housing 12 defines three first protrusions 37 and three second protrusions 38 spaced equidistantly about the central axis 36 of the aerosol-generating device 10. Preferably, the plurality of first protrusions 37 are rotationally offset about the central axis 36 from the plurality of second protrusions 38 to increase or maximise the stability of the metal tube 27 within the chamber 16. The skilled person will appreciate that the housing 12 may define more or fewer of each of the first protrusions 37 and the second protrusions 38 and the arrangement of the first and second protrusions 37, 38 within the chamber 16 may be varied.

The aerosol-generating device 10 also comprises control circuitry 40 and a power supply 42 connected to the inductor coil 24. The control circuitry 40 is configured to provide an alternating electric current from the power supply 42 to the inductor coil 24 to generate an alternating magnetic field. A pressure sensor 46 is arranged in fluid communication with the annular gap 34 between the inductor coil 24 and the cylindrical wall 22 of the chamber 16. During use of the aerosol-generating device 10, the pressure sensor 46 provides signals to the control circuitry 40 indicative of a an air pressure in the annular gap 34.

FIG. 4 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 and the inductor coil 24 so that the aerosol-forming substrate 104 and the susceptor element 114 are positioned inside the windings 26 of the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol.

Airflow through the aerosol-generating system 100 during use is illustrated by the dashed line 116 in FIG. 3. When a user draws on the mouthpiece 110 of the aerosol-generating article 102, a negative pressure is generated in the chamber 16. The negative pressure is sensed by the pressure sensor 46, which provides a signal to the control circuitry 40 indicative of a user drawing on the mouthpiece 110. Advantageously, positioning the pressure sensor 46 in fluid communication with the narrow annular gap 34 amplifies the pressure drop sensed by the pressure sensor 46, which increases the sensitivity of the pressure sensor 46 to puffing by the user. In response to the signal from the pressure sensor 46, the control circuitry 40 may switch on or increase the power supplied from the power supply 42 to the inductor coil 24.

The negative pressure created by a user drawing on the mouthpiece 110 draws air into the chamber 16 at the open end 18 of the chamber. The air entering the chamber 16 then flows through the annular gap 34 between the metal tube 27 and the cylindrical wall 22 of the chamber 16. When the airflow reaches the closed end 20 of the chamber 16, the air flows through the airflow apertures 32 at the second end of the metal tube 27 and enters the aerosol-generating article 102 through the aerosol-forming substrate 104. Airflow through the airflow apertures 32 is facilitated by the second protrusions 38 against which an upstream end of the aerosol-generating 102 is received, which prevents the aerosol-generating article 102 from obstructing the airflow apertures 32.

As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 5 shows a flow diagram illustrating a method 200 of forming an inductor coil for an aerosol-generating device. For context the method 200 will be described with reference to the inductor coil 24 of FIGS. 1 to 3, but the skilled person will appreciate that the method 200 is not limited to forming the inductor coil 24 and may be used to form inductor coils according to alternative embodiments.

In a first step the method 200 comprises providing 202 a tube of electrically conductive material, such as a metal tube 27. In a second step, the metal tube 27 is mounted 204 on a rotatable mandrel to facilitate forming an inductor coil 24 from the metal tube 27. In a third step, the method comprises cutting 206 a helical aperture 29 in at least a portion of the tube 27 to define a helical coil comprising a plurality of windings 26 forming an inductor coil 24. The cutting step 206 may be performed with a fixed laser cutter, wherein the mandrel is simultaneously advanced and rotated with respect to the laser cutter to form the helical aperture 29 in the metal tube 27. A fourth step comprises forming 208 a plurality of apertures in the metal tube 27, such as the plurality of cut-outs 30 and the plurality of airflow openings 32. The apertures may be formed using the same technique for forming the helical aperture 29, such as a laser cutter. The skilled person will appreciate that the forming step 208 may be performed before, after, or simultaneously with the cutting step 206.

In a last step, an internal surface of the inductor coil 24 may be machined 210 to facilitate the insertion of an aerosol-generating article into the inductor coil 24. FIG. 6 illustrates a first example of a machined inductor coil 24 in which each of the windings 26 has been machined to provide a bevelled edge 212 that faces an aerosol-generating article when the aerosol-generating article is inserted into the inductor coil 24 along a first direction 214. FIG. 7 illustrates a second example in which each of the windings 26 has instead been machined to form a rounded surface 216 facing the aerosol-generating article when the aerosol-generating article is inserted into the inductor coil 24 along the first direction 214. Advantageously, machining only one edge of each winding 26 facilitates insertion of an aerosol-generating article into the inductor coil 24 and facilitates retention of the aerosol-generating article in the inductor coil 24. The un-shaped edge of each winding 26 resists removal of the aerosol-generating article from the inductor coil 24 until the aerosol-generating article shrinks during use of the aerosol-generating system 100.

FIG. 8 shows a cross-sectional view of an aerosol-generating device 300 according to a second embodiment of the invention. The aerosol-generating device 300 is similar to the aerosol-generating device 10 described with reference to FIGS. 1 to 3 and like reference numerals are used to designate like parts.

The aerosol-generating device 300 differs from the aerosol-generating device 10 by the addition of a susceptor element 314. The susceptor element 314 has an elongate shape and extends into the chamber 16 from the closed end 20 of the chamber 16. The susceptor element 314 extends along the central axis 36 of the aerosol-generating device 300 so that the inductor coil 24 extends concentrically around the susceptor element 314.

FIG. 9 shows a cross-sectional view of an aerosol-generating system 370 comprising the aerosol-generating device 300 of FIG. 8 and an aerosol-generating article 172. The aerosol-generating system 370 is similar to the aerosol-generating system 100 described with reference to FIG. 4 and like reference numerals are used to designate like parts.

The aerosol-generating system 370 differs by the absence of a susceptor element in the aerosol-generating article 372. When the aerosol-generating article 372 is inserted into the chamber 16, the susceptor element 314 of the aerosol-generating device 300 is received within the aerosol-forming substrate 104 of the aerosol-generating article 372. Once the aerosol-generating article 372 has been inserted into the chamber 16, the operation of the aerosol-generating system 370 is identical to the operation of the aerosol-generating system 100 described with reference to FIG. 4.

FIG. 10 shows a cross-sectional view of an aerosol-generating device 400 according to a third embodiment of the invention. The aerosol-generating device 400 is similar to the aerosol-generating device 10 described with reference to FIGS. 1 to 3 and like reference numerals are used to designate like parts.

The aerosol-generating device 400 differs from the aerosol-generating device 10 by the configuration of the plurality of cut-outs 430 and the plurality of airflow openings 432 in the metal tube 427 of the inductor coil 424. Specifically, in the aerosol-generating device 400, each of the cut-outs 430 and the airflow openings 432 has a larger, hexagonal shape compared to the smaller, circular shape of the cut-outs 30 and the airflow openings 32 of the aerosol-generating device 10. Advantageously, the larger size of the cut-outs 430 and the airflow openings 432 further reduces the weight of the inductor coil 24 and further reduces the conduction of heat generated in the windings 426 towards the first and second ends of the metal tube 427. Advantageously, the hexagonal shape of the cut-outs 430 facilitates nesting of adjacent rows of the cut-outs 430.

The operation and use of the aerosol-generating device 400 is identical to the operation and use of the aerosol-generating device 10 described above. The skilled person will appreciate that the aerosol-generating device 400 may be modified to include a susceptor element as described above with respect to the aerosol-generating device 300.

FIG. 11 shows a cross-sectional view of an aerosol-generating device 500 according to a fourth embodiment of the invention. The aerosol-generating device 500 is similar to the aerosol-generating device 10 described with reference to FIGS. 1 to 3 and like reference numerals are used to designate like parts.

The aerosol-generating device 500 differs from the aerosol-generating device 10 by the configuration of the inductor coil 524. Specifically, the metal tube 527 used to form the inductor coil 524 is shorter and defines only the plurality of windings 526. In other words, the metal tube 527 does not define any cut-outs or airflow openings at the first and second ends of the metal tube 527. Due to the lack of airflow openings in the metal tube 527, the metal tube 527 is arranged to abut the plurality of second protrusions 38 so that the second end of the metal tube 527 is spaced apart from the closed end 20 of the chamber 16. The space between the second end of the metal tube 527 and the closed end 20 of the chamber 16 allows air to flow from the annular gap 34 to an aerosol-generating article received inside the inductor coil 524 during use of the aerosol-generating device 500.

The operation and use of the aerosol-generating device 500 is identical to the operation and use of the aerosol-generating device 10 described above. The skilled person will appreciate that the aerosol-generating device 500 may be modified to include a susceptor element as described above with respect to the aerosol-generating device 300.

1.-22. (canceled)

23. An aerosol-generating device, comprising:
an inductor coil comprising:
a first tubular portion of electrically conductive material,
a second tubular portion of electrically conductive material, and
a helical coil of electrically conductive material extending between the first tubular portion of electrically conductive material and the second tubular portion of electrically conductive material;
a chamber configured to receive at least a portion of an aerosol-generating article, wherein the inductor coil is arranged such that, when an aerosol-generating article is inserted into the chamber, at least part of the aerosol-generating article is received within the inductor coil and the inductor coil directly contacts the aerosol-generating article; and
a power supply and control circuitry connected to the inductor coil and configured to provide an alternating electric current to the inductor coil such that the inductor coil is configured to generate an alternating magnetic field.

24. The aerosol-generating device according to claim 23, wherein the helical coil is formed integrally with the first tubular portion and the second tubular portion.

25. The aerosol-generating device according to claim 23,
wherein each of the first tubular portion, the second tubular portion, and each turn of the helical coil has a maximum width extending in a direction parallel to a longitudinal axis of the inductor coil, and
wherein a maximum width of each of the first tubular portion and the second tubular portion is greater than the maximum width of each turn of the helical coil.

26. The aerosol-generating device according to claim 23, further comprising a plurality of discrete apertures in at least one of the first tubular portion of electrically conductive material and the second tubular portion of electrically conductive material.

27. The aerosol-generating device according to claim 26, further comprising the plurality of discrete apertures in both the first tubular portion of electrically conductive material and the second tubular portion of electrically conductive material.

28. The aerosol-generating device according to claim 26, wherein the plurality of discrete apertures are distributed symmetrically in a circumferential direction extending around a longitudinal axis of the inductor coil.

29. The aerosol-generating device according to claim 23, further comprising a layer of electrically insulating material extending around an outer surface of the first tubular portion, the second tubular portion, and the helical coil.

30. The aerosol-generating device according to claim 23,
wherein the helical coil of electrically conductive material has an inner surface, and
wherein at least one edge of the turns of the helical coil comprises a bevel, a chamfer, or a fillet.

31. The aerosol-generating device according to claim 23, further comprising a susceptor element.

32. The aerosol-generating device according to claim 23, wherein the chamber comprises an open first end through which at least a portion of an aerosol-generating article is configured to be inserted into the chamber and a closed second end opposite open first end.

33. An aerosol-generating system, comprising:
the aerosol-generating device according to claim 23; and
an aerosol-generating article comprising an aerosol-forming substrate.

34. A method of forming an inductor coil for an aerosol-generating device, the method comprising:
providing a tube of electrically conductive material;
cutting a helical aperture in at least a portion of the tube of electrically conductive material to define a helical coil of the electrically conductive material, the helical coil of the electrically conductive material forming an inductor coil for an aerosol-generating device; and
cutting a plurality of discrete apertures in the tube of electrically conductive material.

35. The method according to claim 34,
wherein the step of cutting the helical aperture comprises cutting the helical aperture in only a portion of the tube of electrically conductive material to define a first end portion of the tube, a second end portion of the tube, and a central portion of the tube extending between the first end portion and the second end portion, and
wherein the helical aperture extends along only the central portion of the tube so that the inductor coil comprises the first end portion of the tube, the second end portion of the tube, and the helical coil of electrically conductive material extending between the first end portion of the tube and the second end portion of the tube.

36. The method according to claim 35, wherein the step of cutting the plurality of discrete apertures comprises cutting the plurality of discrete apertures in at least one of the first end portion of the tube of electrically conductive material and the second end portion of the tube of electrically conductive material

37. The method according to claim 35, wherein the step of cutting the plurality of discrete apertures comprises cutting the plurality of discrete apertures in both of the first end portion of the tube of electrically conductive material and the second end portion of the tube of electrically conductive material.

38. The method according to claim 35,
wherein each of the first end portion of the tube, the second end portion of the tube, and each turn of the helical coil has a maximum width extending in a direction parallel to a longitudinal axis of the tube, and
wherein a maximum width of each of the first end portion of the tube and the second end portion of the tube is greater than the maximum width of each turn of the helical coil.

39. The method according to claim 34, wherein the step of cutting the helical aperture comprises rotating and advancing the tube of electrically conductive material relative to a fixed cutting device.

40. The method according to claim 34,
wherein the tube of electrically conductive material has an inner surface, and
wherein the method further comprises shaping at least one edge of the turns of the helical coil of electrically conductive material at the inner surface of the tube of electrically conductive material.

41. The method according to claim 40, wherein the shaping comprises providing the at least one edge of the turns of the helical coil of electrically conductive material with a bevel, a chamfer, or a fillet.

42. The method according to claim 34, further comprising repeating at least the step of cutting the helical coil along a length of the tube of electrically conductive material to form a plurality of connected inductor coils along the tube of electrically conductive material.

43. The method according to claim 42, further comprising cutting the tube of electrically conductive material between consecutive connected inductor coils to form a plurality of separated inductor coils.

44. An inductor coil formed according the method of claim 34.
